(19) United States
(12) Patent Application Publication
(10) Pub. No.: US 2023/0150859 A1
(43) Pub. Date: May 18, 2023

(54) LOW BORON CONTENT CULINARY GLASS COMPOSITION

(71) Applicant: ARC FRANCE, Arques (FR)

(72) Inventors: Rodolphe DELAVAL, Arques (FR); Sébastien DONZE, Arques (FR)

(73) Assignee: ARC FRANCE, Arques (FR)

(21) Appl. No.: 17/917,865

(22) PCT Filed: Apr. 1, 2021
(86) PCT No.: PCT/FR2021/050585

§ 371 Date: Oct. 7, 2022

(30) Foreign Application Priority Data
Apr. 10, 2020 (FR) 2003647

(51) Int. Cl. C03C 3/087; C03C 4/20

(52) U.S. Cl. CPC C03C 3/087; C03C 4/20

(57) ABSTRACT

[Low boron content culinary cooking glass composition comprising, by weight, SiO₂+Al₂O₃ more than 73.0%, CaO+MgO at least 8.0%, SiO₂ from 70.0 to 78.0%, Na₂O from 8.0 to 12.0%, CaO from 4.0 to 8.0%, Al₂O₃ less than 5.0%, MgO from 3.0 to 11.0%, K₂O less than 2.0%, SrO less than 5.0%, SO₃ less than 0.25% and B₂O₃ less than 0.20%, having a glass transition temperature Tg less than 700° C., preferably less than 640° C., a coefficient of expansion less than 75.0 10⁻⁷ K⁻¹ and a specific thermal stress less than 0.75 MPa/K.]

### FIELD OF THE INVENTION

The present invention relates to the field of culinary glass for cooking.

### BACKGROUND

In glass making, there are specific composition glasses responding to particular specifications. Certain pharmaceutical glasses must resist specific chemical agents. Optical glasses have wavelengths chosen for transmission of visible or non-visible light. Industrial glasses meet a variety of requirements.

In the field of household glass, culinary cooking glass differs from drinking glass through a requirement for resistance to thermal shocks. Hence, it is possible to cook in and present to the table the same glass dish.

Certain articles for use in culinary cooking contain large proportions by weight of boron oxide, approximately 11 to 13%. The term used to describe these to the general public is “borosilicate glass”. In general, boron reduces the expansion coefficient and improves the resistance to thermal shocks. However, the production of a glass containing boron requires special production equipment, very high-strength refractories and a high melting temperature. This results in a poor energy balance.

Other articles for culinary use have a soda-lime composition close to that of drinking glasses and are the subject of strong tempering generating high residual stresses in the glass. The thermal expansion coefficient is approximately 90.10⁻⁷ K⁻¹. The glass is then resistant to thermal shocks in a specific range of temperatures and/or temperature variation but, if the range is exceeded, then the breaking of the glass releases a large amount of energy and an effect sometimes qualified as an explosion with the protection of numerous glass fragments and significant noise.

The applicant has sought to improve this situation.

The applicant has carried out research with a view to providing a culinary cooking article that can be produced in a soda-lime glass furnace under normal operating conditions, while having good resistance to thermal shock and a reduced risk of explosion during use.

### SUMMARY

The following culinary cooking glass composition with reduced boron content has been selected, comprising by weight: SiO₂+Al₂O₃ more than 73.0%, CaO+MgO at least 8.0%, SiO₂ from 70.0 to 78.0%, Na₂O from 8.0 to 12.0%, CaO from 4.0 to 8.0%, Al₂O₃ less than 5.0%, MgO from 3.0 to 11.0%, K₂O less than 2.0%, SrO less than 5.0%, SO₃ less than 0.25% and B₂O₃ less than 0.20%. The composition has a glass transition temperature Tg less than 700° C., a coefficient of expansion less than 75.0 10⁻⁷ K⁻¹ and a specific thermal stress less than 0.75 MPa/K. Said extension coefficient is advantageous for obtaining a stressed state in the finished glass reducing the risk of explosion during use. The composition can be produced in a soda-lime glass furnace.

The glass transition temperature Tg is preferably less than 640° C. The glass transition temperature Tg can be measured according to standard ISO 7884-8:1987. The protocol can be identical for measuring the coefficient of thermal expansion or CTE. The CTE is measured according to standard ISO 7991:1987.

In an embodiment, the melting point is less than 1600° C., preferably less than 1570° C.

In an embodiment, the composition comprises, by weight: SiO₂+Al₂O₃ more than 76.0%.

In an embodiment, the composition comprises, by weight: CaO+MgO at least 9.0%.

In an embodiment, the composition comprises, by weight: SiO₂ from 72 to 78.0%.

In an embodiment, the composition comprises, by weight: CaO from 4.0 to 8.0%.

In an embodiment, the composition comprises, by weight: Al₂O₃ from 1.0 to 5.0%

In an embodiment, the composition comprises, by weight: SrO less than 1.5%.

In an embodiment, the composition is without voluntary addition of B₂O₃.

In an embodiment, the composition comprises, by weight: SiO₂ from 74.0 to 76.0%.

In an embodiment, the composition comprises, by weight: Na₂O from 10.0 to 12.0%.

In an embodiment, the composition comprises, by weight: Al₂O₃ from 1.6 to 4.0%, in particular 2.0 to 4.0%, preferably 1.7 to 3.0%.

In an embodiment, the composition comprises, by weight: MgO from 3.0 to 5.0%.

In an embodiment, the composition comprises, by weight: K₂O less than 1.0%.

In an embodiment, the composition comprises, by weight: SrO at most 1.0%.

In an embodiment, the composition comprises, by weight: SO₃ less than 0.25%. The sulfate used as a refining agent is partly found in the fumes in the case of a combustion furnace, and is then captured in the treatment systems for said fumes. The raw materials at the inlet to the glass-making oven generally comprise a proportion by weight of sulfate greater than the proportion by weight of sulfate in the glass.

In an embodiment, the composition comprises, by weight: B₂O₃ less than 0.20%.

In an embodiment, the composition has a glass transition temperature Tg less than 610° C., preferably less than 590° C.

In an embodiment, the composition has a softening point PR less than 660° C., preferably less than 650° C.

In an embodiment, the composition has a density greater than 2.30 and less than 2.48.

In an embodiment, the composition comprises, by weight: CaO from 5.0 to 6.5%.

In an embodiment, the composition is without voluntary addition of BaO.

In an embodiment, the composition is without voluntary addition of TiO₂.

In an embodiment, the composition is without voluntary addition of ZrO₂.

In an embodiment, the composition is without voluntary addition of SnO₂.

In an embodiment, the composition is without voluntary addition of ZnO.

In an embodiment, the composition is without voluntary addition of Cl.

In an embodiment, the composition is without voluntary addition of As.

In an embodiment, the composition is without voluntary addition of Sb.

In an embodiment, the composition has less than 0.20% CeO₂.

In an embodiment, the composition has less than 0.10% SO₃ preferably less than 0.05% SO₃.

In an embodiment, the composition has a glass transition temperature Tg less than 585° C.

In an embodiment, the composition has a coefficient of expansion less than 74.0 10⁻⁷ K⁻¹ an.

In an embodiment, the composition is without voluntary addition of F. In an embodiment, the composition is without voluntary addition of Pb.

In an embodiment, strontium oxide is substituted by a mixture of calcium and magnesium oxides.

### DETAILED DESCRIPTION OF THE PREFERRED EMBODIMENTS

The composition combines the features of coefficient of thermal expansion less than 75.0˜10⁻⁷ K⁻¹, softening point <675° C., practical melting temperature <1500° C. measured in the glass bath, correct glass quality with refining carried out using sodium sulfate, compatibility with the centrifugation method for forming the article.

The centrifugation was found to be easier with the formulation defined by the narrow ranges above, and this led to the best thermal performance.

Furthermore, certain glasses are mentioned in fields other than the culinary arts, with low coefficients of thermal expansion and other requirements. This is the case, in particular, for certain LCD screen glasses, certain neutral glasses with high hydrolytic resistance. These are often glasses low in alkali oxides but rich in alumina and in alkaline earths (CaO, BaO, SrO . . . ) but which are only used in flat glass and/or annealed glass and/or at the laboratory stage. In several cases, the presence, in low proportion, of tin and chlorine oxides is noted, elements which must correspond to the refining agents, often used for poorly fusible glasses.

A basis close to that of LAS (lithium-aluminum-silicon) vitroceramics, glasses having a coefficient of thermal expansion similar to that of borosilicate (30 á 40·10⁻⁷ K⁻¹) have been developed for the thermal protection of domestic oven doors. Such glasses are boron-free and have very low alkali metal contents, essentially of lithium (<2%) and certain particular oxides (TiO2, BaO, ZrO2 . . . ) etc. This type of composition does not represent a realistic alternative because it shares few elements with soda-lime glass and requires dedicated mixing, melting and forming facilities. Other publications discuss the resistance to thermal shock of the glass as a material and proposes approaching this concept by calculating the “specific thermal stress” according to “Fundamental of inorganic glasses”, second edition, A. K. Varshneya pages 258-262 or FR 2 791 343. This parameter takes into account the modulus of elasticity E and the Poisson coefficient u in addition to the coefficient of thermal expansion CTE. The specific thermal stress is calculated according to the formula: E×CTE/(1−u).

The specific thermal stress is a parameter reflecting the resistance to temperature changes.

Other authors also consider the concept of internal stress linked to cooling, but for simple cases such as flat glass. This approach is not applicable in the context of hollow articles of complex and multiple shape.

The applicant has identified that the resistance of glass articles to thermal shock is linked to a plurality of factors, such as the chemical nature of the material itself, which determines the coefficient of thermal expansion, the level of internal stress produced during the thermal tempering step, the thickness of the glass and the regularity of its distribution within a given article.

The use of centrifugation makes it possible to have articles with a relatively homogeneous thickness distribution, as well as reduced contact between mold and hot glass. These two factors are advantageous for improving the thermal resistance and mechanical strength.

In practice, the final quality of the glass is important for the strength of the parts, since small inclusions (bubbles, unfused material, stones, etc.), even if invisible to the naked eye, are sufficient to constitute a point of weakness which will be the origin of the breaking of objects.

Here, thermal shock is understood to mean a rapid variation in temperature over a given duration, in particular according to standard EN13834 requiring no breakage due to thermal shock for a temperature difference of 180° C. with three articles preheated to 200° C. then immersed in water at 20° C.; and holding the articles at a temperature of 250° C. for 1 hour. Alongside this, there is also standard EN138343 describing a so-called “progressive” test methodology on 20 pieces with an increasing temperature difference, making it possible to determine the resistance to thermal shock. Finally, additional characterizations, close to the final use, are also useful, in particular progressive tests during which only certain parts of the preheated articles are immersed in water at 20° C.

Furthermore, said glass is compatible with well-known production means for soda-lime glass, in order to avoid having to use dedicated facilities. This point concerns, in particular, melting tools, but also forming tools which must incorporate all the known methods. Indeed, the centrifuge method is considered alongside the conventional press method, and the blowing method, which makes it possible to form a range of articles combining light weight and performance. These last two methods generally give finer and more uniform thicknesses which are advantageous for the thermal resistance of the articles. Their control requires glasses with a reasonable melting point like soda-lime glasses, and not high melting points like certain vitroceramic glasses.

In terms of product, the applicant has developed a vitreous material for culinary cooking use, the formulation of which is substantially free of any volatile element likely to be found in fumes, in particular boron. Said material avoids the explosion of articles during excessive thermal shocks, in order to greatly reduce the risk of harmful injury to the end user. Said glass, for which the thermal properties have been optimized, in particular with a thermal expansion coefficient of less than 75·10⁻⁷ K⁻¹, makes it possible to obtain both good thermal performance and low fragmentation of the articles.

Five formulations were initially identified and tested in a first approach at the laboratory stage, then three were subsequently considered at the prototype furnace stage. One formulation showed a significant improvement with respect to a soda-lime glass V3 taken as reference and with respect to another glass V2 taken as reference:

V1: 74.8% SiO2; 11.0% Na2O; 6.0% CaO; 3.0% Al₂O₃; 4.0% MgO; 1.0% SrO; 0.20% SO3

V2: 64.9% SiO2; 10.3% Na2O; 9.4% CaO; 8.5% Al₂O₃; 6.7% MgO; 0.2% SO3 in weight %. The composition V2 is used here as a comparative example. Several glass compositions were tested at the semi-industrial stage, during test phases on a gas-heated prototype furnace with a capacity of 50 kg of molten glass per day with the production of annealed samples on forming machines. A final step of repeated tempering was carried out under comparative conditions, with adaptation of the temperature rise profile with regard to the various softening points of the reference soda-lime glass. The thermal characterizations performed on these comparable samplings (around a hundred of these pieces produced in the form of a salad bowl) revealed a significant increase in the performance of the final articles.

Four formulations V1, V2 for comparison, V3 for comparison and V4 for comparison were tested on approximately 25 articles on a prototype oxygen-combustion furnace with production of annealed samples on a unitary forming machine. The shape tested is axial, of the circular salad bowl type.

Then, around a hundred pieces qualified as first choice, obtained after sorting to eliminate bubble defects, stone defects etc., were produced for each of the two references as well as soda-lime glass. As before, chemical refining was carried out using sodium sulfate.

This step also allowed it to be appreciated that the centrifugation was easier for composition V1 than for composition V2.

TABLE

| Data | V1 | V2 | V3 |
|---|---|---|---|
| Formulation wt % | 74.8SiO2 11Na2O | 64.9SiO2 10.3Na2O | 73.2SiO2 13.16Na2O |
| theoretical +/−0.1% | 6CaO 3Al2O3 4MgO | 9.4CaO 8.5Al2O3 | 10.8CaO 1.3Al2O3 |
| | 1SrO 0.2SO3 | 6.7MgO 0.2SO3 | 1.35MgO 0.2SO3 |
| CTE 10−7 K⁻¹ | 71 | 75 | 87 |
| PR ° C. | 640 | 675 | 615 |
| Furnace set temp. ° C. | 1500 | 1450-1500 | 1450 |
| Thermal stress MPa/K | 0.703 | 0.774 | 0.83 |

Each sample was divided into 3 equivalent batches, in order to be able to apply settings and increasing blowing and tempering levels (standard, +20%, +40%). The temperature profiles were adapted to the properties of the glasses produced, in particular the softening point. The absence of breakage of articles during the tempering step per se was noted.

The thermal characterization tests did not reveal indisputable changes between the various tempering settings of a given formulation. On the other hand, composition V1 clearly gives better performance than composition V2, which furthermore agrees with the calculation of the Young's modulus and the coefficient of thermal expansion giving the specific thermal stress indicated above. The composition V3 gives less good results, including a coefficient of thermal expansion that is too high. The composition V2 gives a coefficient of thermal expansion that is not sufficiently certain.

Static corrosion tests of the furnace refractories by hot glass have given satisfactory results.

High temperature viscosity measurements have shown that formulation V2 gives a very short working stage, making the forming more difficult to control.

Tests on the possibility of coloring, have shown that formulation V1 appears to be the most flexible for accepting an addition of coloring oxides, in small proportions.

The parts produced by pressing as well as by centrifugation have then undergone the thermal tempering step, in order to finally pass the tests for compliance with culinary standards. The fragmentation obtained is clearly manifestly more advantageous than for tempered soda-lime glass.

An industrial test of more than 10 days was carried out on an industrial soda-lime glass furnace with capacity greater than 50 tons per day, in continuous operation with composition V1.

The culinary cooking glass poses no compatibility problem with soda-lime glass, the two transitions taking place without incident.

The melting of the culinary cooking glass was correctly carried out with a refining with sodium sulfate, the efficiency of which is clearly greater here due to the low content of this element (<0.07%) in the glass. The final quality level was adjudged to be perfectly usable and free of defects (trapped gas bubbles, unfused material and/or stone, etc.). The raw materials were melted in the same temperature and heating power ranges as a soda-lime glass.

The fact that the raw materials are low in volatile elements, other than the refining agents, and in particular in boron, implies that the losses of material by evaporation are minimal here, which makes the production compatible with regenerator furnaces, unlike borosilicate glasses which require special furnaces.

In terms of forming, the culinary cooking glass has been used both on pressing lines and on a centrifugation line. Hence, the culinary cooking glass article can be made of pressed glass or centrifuged glass. Blowing is also possible.

For this centrifugation method, the line operated continuously without major problem throughout the test period, requiring only the drop temperature to be adapted in order to maintain a suitable viscosity. In the two cases in question, the speeds and yield of the forming machines did not differ particularly between the culinary cooking glass and the soda-lime glass for a drinking cup.

The centrifugation was particularly advantageous for having articles with the uniform thickness distribution, as well as a reduced contact between mold and hot glass, these two properties being advantageous for improving the thermal resistance and mechanical strength. Indeed, the skin of the surface glass is more uniform and without defect, the risks of potential sources of breakage are minimized. Reference is made here to the patent FR 3 001 451 of the applicant.

In terms of heat treatment, the culinary cooking glass has been used on the tempering lines usually used for soda-lime glass.

Finally, the thermal tests on the various articles produced have clearly validated the successful achievement of the limit values defined by the standard EN13834 for thermal shock breakage. They also showed improvement in terms of fragmentation compared with soda-lime glass, which is especially sensitive to tests in which a part of the article at 200° C. is placed in contact with water at 20° C.

The thermal resistance is compatible with culinary cooking use. The fragmentation is devoid of explosive character. The glass-making formulation by weight, plus or minus 0.1%, of 74.8% SiO2, 11% Na2O, 6% CaO, 3% Al₂O₃, 4% MgO, 1% SrO and less than 0.2% SO3 can satisfy:

Compatibility with an air/gas furnace with regenerator.

Compatibility with an oxygen/gas furnace.

Refining with sulfate.

Compatibility with coloring by known coloring agents

Compatibility with household glass manufacturing facilities.

Adapting centrifugation for forming the article.

Adapting pressing for forming the article.

Operation at rates and yields comparable to soda-lime glass.

Absence of boron and undesirable elements.

A moderate internal stress level after tempering.

Compliance with the thermal resistance requirements of standard EN13834.

Controlled and gentle fragmentation in the event of breaking.

A preparation with only the glass-making composition is possible, but cullet facilitates and accelerates the melting kinetics.

Quite substantial sampling made it possible to carry out all of the thermal but also mechanical characterizations.

Thermal shock tests by immersing in water, the positive results of which validated the compliance with the thresholds defined in standard EN13834 (no breakage after a thermal shock immersed in water with ΔT=180° C. for 3 articles and articles held for 1 hour at 250° C.). The estimate of the thermal resistance according to the protocol defined in standard EN1183, in other words the monitoring of breakages during a progressive test on 20 articles immersed in water was satisfactory. The estimate of the strength by monitoring the breakages during progressive tests on 10 articles for which the bottom was immersed in water, beyond the standard, was satisfactory. A filling test of 5 articles at 20° C. with water preheated to 90° C. was satisfactory.

It would appear to be clear that the resistance to various thermal shocks of the culinary class of formulation V1 is very much greater than that of the glass of formulation V3 and that of the glass a formulation V4.

Formulation V1 makes it possible to obtain a colorless glass that is suitable for coloring, a satisfactory start-up of the furnace and operation with cooking glass cullet. A decrease in CaO to below the lower limit is detrimental to the coefficient of thermal expansion.

TABLE

| | V1 | V2 | V3 | V4 |
|---|---|---|---|---|
| Oxides | wt. % | wt. % | wt. % | wt. % |
| SiO2 | 74.80 | 64.90 | 72.75 | 73.80 |
| Al2O3 | 3.00 | 8.50 | 1.50 | 2.00 |
| K2O | 0 | 0 | 0 | 1.50 |
| Na2O | 11.00 | 10.30 | 13.35 | 11.50 |
| Li2O | 0 | 0 | 0 | 0 |
| MgO | 4.00 | 6.70 | 1.40 | 10.00 |
| CaO | 6.00 | 9.40 | 10.80 | 0.50 |
| BaO | 0 | 0 | 0 | 0 |
| ZnO | 0 | 0 | 0 | 0 |
| B2O3 | 0 | 0 | 0 | 0 |
| SrO | 1.00 | 0 | 0 | 0.50 |
| TiO2 | 0 | 0 | 0 | 0 |
| ZrO2 | 0 | 0 | 0 | 0 |
| % tot | 99.80 | 99.80 | 99.80 | 99.80 |
| CTE 10−7 | 73.9 | 76.5 | 87.7 | 75.8 |
| K⁻¹ | | | | |
| Tg ° C. | 583 | 626 | 565 | 588 |
| PR ° C. | 640 | 663 | 605 | 639 |
| Density | 2.43 | 2.53 | 2.51 | 2.44 |
| Tf (log2) ° C. | 1560 | | 1430-1450 | |

where CTE is the coefficient of thermal expansion, Tg the glass transition temperature, PR the softening point and Tf(log 2) the melting temperature estimated from log 2 of the viscosity.

The search for a raw material source, in particular for magnesium oxide, has led to the preferred choice of dolomite which is already used in soda-lime glass.

Work has begun on the search for a transparent culinary cooking glass. Among its properties, the aim is for its formulation to be substantially free of any volatile element, in particular boron oxide.

1. Low boron content culinary cooking glass composition comprising, by weight, SiO₂+Al₂O₃ more than 73.0%, CaO+MgO at least 8.0%, SiO₂ from 70.0 to 78.0%, Na₂O from 8.0 to 12.0%, CaO from 4.0 to 8.0%, Al₂O₃ less than 5.0%, MgO from 3.0 to 11.0%, K₂O less than 2.0%, SrO less than 5.0%, SO₃ less than 0.25% and B₂O₃ less than 0.20%, having a glass transition temperature Tg less than 700° C. a coefficient of expansion less than 75.0 10⁻⁷ K⁻¹ and a specific thermal stress less than 0.75 MPa/K.

2. The composition according to claim 1, wherein the melting point of the composition is less than 1600° C.

3. The composition according to claim 1, wherein the composition comprises, by weight: SiO₂+Al₂O₃ more than 76.0%, CaO+MgO at least 9.0%, SiO₂ from 72.0 to 78.0%, Na₂O 10.0 to 12.0%, CaO 4.0 to 8.0%, Al₂O₃ from 1.0 to 5.0%, SrO less than 1.5%, B₂O₃ with no voluntary addition.

4. The composition according to claim 1, wherein the composition comprises, by weight: Al₂O₃ from 1.6 to 4.0%.

5. The composition according to claim 1, wherein the composition comprises, by weight: SiO₂ from 74.0 to 76.0%, Na₂O from 10.0 to 12.0%, Al₂O₃ from 2.0 to 4.0%, MgO from 3.0 to 5.0%, K₂O less than 1.0%, SrO at most 1.0%, SO₃ less than 0.25% and B₂O₃ less than 0.20%.

6. The composition according to claim 5, having a glass transition temperature Tg less than 610° C., a softening point PR less than 660° C., and the density greater than 2.30 and less than 2.48.

7. The composition according to claim 1, wherein the composition comprises, by weight: CaO from 5.0 to 6.5%.

8. The composition according to claim 1, wherein the composition comprises, by weight: CeO₂ less than 0.20%.

9. The composition according to claim 1, wherein the composition comprises, by weight: SO₃ less than 0.10%.

10. The composition according to claim 1, wherein the composition comprises, by weight: BaO with no voluntary addition, TiO₂ with no voluntary addition, ZrO₂ with no voluntary addition, ZnO with no voluntary addition, As with no voluntary addition, Sb with no voluntary addition, F with no voluntary addition and Pb with no voluntary addition.

11. The composition according to claim 1, wherein the composition comprises, by weight: SnO₂ with no voluntary addition, ZnO with no voluntary addition, Cl with no voluntary addition.

12. The composition according to claim 1, having at least one of: a glass transition temperature Tg less than 585° C., or a coefficient of expansion less than 74.0 10⁻⁷ K⁻¹ an.

13. Article of culinary cooking glass comprising the composition of claim 1.
